(19) United States
(12) Patent Application Publication
(10) Pub. No.: US 2025/0228269 A1
(43) Pub. Date: Jul. 17, 2025

(54) COMPOSITIONS

(71) Applicant: GIVAUDAN SA, VERNIER (CH)

(72) Inventor: Mariaelena Zuniga HAYES, Cincinnati, OH (US)

(21) Appl. No.: 18/700,566

(22) PCT Filed: Oct. 10, 2022
(86) PCT No.: PCT/EP2022/078133

§ 371 Date: Apr. 11, 2024

Related U.S. Application Data
(60) Provisional application No. 63/254,750, filed on Oct. 12, 2021.

(51) Int. Cl. A23L 2/52; A23L 2/39

(52) U.S. Cl. CPC A23L 2/52; A23L 2/39

(57) ABSTRACT

A composition including plant-derived carbohydrate fiber that is not a beta-glucan fiber fiber and a beta-glucan fiber as mouthfeel-improving additives for a consumable are disclosed. A consumable containing the composition of the plant-derived non-beta-glucan carbohydrate fiber and beta-glucan fiber as mouthfeel-improving additives, and methods for preparing a consumable including the mouthfeel-improving composition and for improving the mouthfeel of a consumable by adding the mouthfeel-improving composition to a consumable base are also disclosed.

### TECHNICAL FIELD

The present disclosure relates to a composition for improving the mouthfeel of a consumable, a consumable including the composition, a method for preparing a consumable including the composition, and a method for improving the mouthfeel of a consumable by adding the mouthfeel-improving composition to a consumable base. The present disclosure more particularly relates to for improving the mouthfeel of a consumable beverage, a beverage including the composition, a method for preparing a beverage including the composition, and a method for improving the improving the mouthfeel of a beverage by adding the mouthfeel-improving composition to a beverage base.

### BACKGROUND

Dry beverage compositions and powdered beverage mixes are powdered mixes that are reconstituted with a drinkable liquid, such as water, to provide a ready-to-drink beverage. Such powdered mixes are typically formulated to achieve desired mouthfeel, color, flavor, and nutritional characteristics when the dry mix is reconstituted with the drinkable liquid.

Powdered beverage mixes are typically thickened with gums, such as xanthan gum, guar gum, pectin, or the like to provide a desired target mouthfeel. However, the use of such gums to thicken the beverages often results in an undesired “gummy” mouthfeel of the reconstituted beverage.

It is therefore desirable in the art to provide a powdered beverage mix that includes additives, which when the dry powder mix is reconstituted with a drinkable liquid, results in a more suitable mouthfeel and texture.

### SUMMARY

Disclosed is a composition comprising at least one carbohydrate fiber that is not a beta-glucan and at least one beta-glucan fiber.

According to certain illustrative embodiments, the composition comprises at least one plant-derived carbohydrate fiber that is not a beta-glucan and at least one plant-derived beta-glucan fiber.

According to certain illustrative embodiments, disclosed is a composition consisting essentially of at least one plant-derived carbohydrate fiber that is not a beta-glucan and at least one plant-derived beta-glucan fiber.

According to certain illustrative embodiments, disclosed is a composition consisting of at least one plant-derived carbohydrate fiber that is not a beta-glucan and at least one plant-derived beta-glucan fiber.

According to further illustrative embodiments, disclosed is a consumable comprising a consumable base, at least one plant-derived carbohydrate fiber that is not a beta-glucan, and at least one plant-derived beta-glucan fiber.

According to further illustrative embodiments, disclosed is a beverage comprising a beverage base, at least one plant-derived carbohydrate fiber that is not a beta-glucan and at least one plant-derived beta-glucan fiber.

According to further illustrative embodiments, disclosed is a ready-to-drink beverage comprising a beverage base, at least one plant-derived carbohydrate fiber that is not a beta-glucan and at least one plant-derived beta-glucan fiber.

According to further illustrative embodiments, disclosed is a powdered beverage composition comprising a beverage base, at least one plant-derived carbohydrate fiber that is not a beta-glucan and at least one plant-derived beta-glucan fiber.

According to further illustrative embodiments, disclosed is a method for preparing a consumable comprising adding to a consumable base at least one plant-derived carbohydrate fiber that is not a beta-glucan and at least one plant-derived beta-glucan fiber.

According to further illustrative embodiments, disclosed is a method of improving the mouthfeel of a consumable comprising adding mouthfeel-improving amounts of at least one plant-derived carbohydrate fiber that is not a beta-glucan and at least one plant-derived beta-glucan fiber to a consumable base.

According to further illustrative embodiments, disclosed is the use of a combination of at least one plant-derived carbohydrate fiber that is not a beta-glucan and at least one plant-derived beta-glucan fiber to improve the mouthfeel of a consumable.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

Disclosed is a composition comprising non-beta glucan carbohydrate fibers and beta-glucan fibers. According to certain embodiments, the composition comprises at least one plant-derived non-beta-glucan carbohydrate fiber and at least one plant-derived beta-glucan fiber.

According to certain illustrative embodiments, the non-beta-glucan carbohydrate fibers and the beta-glucan fibers may be separately added as individual components to a dry powder beverage base formulation in mouthfeel-improving amounts of these additives. According to other embodiments, the non-beta-glucan carbohydrate fibers and beta-glucan fibers may be formulated into a composition comprising both mouth-feel improving additives, and the composition added to a dry powder beverage base formulation. The composition comprising the at least one non-beta-glucan carbohydrate fiber and the at least one beta-glucan fiber is formulated to be incorporated into a dry powder beverage mix to be reconstituted with a drinkable liquid, such as water, to provide a ready-to-drink beverage. The mouthfeel-improving additives of the at least one non-beta-glucan carbohydrate fiber and the at least one beta-glucan fiber are present in the composition or a consumable in mouthfeel-improving amounts to improve the mouthfeel of the reconstituted beverage. According to certain illustrative embodiments, the mouthfeel-improving additives of the at least one plant-derived non-beta-glucan carbohydrate fiber and the at least one beta-glucan fiber are present in a dry powder beverage mix in mouthfeel-improving amounts to improve the mouthfeel of the resulting beverage after the dry powder beverage mix has been reconstituted with a drinkable liquid. The term “improved mouthfeel” means that a ready-to-drink beverage prepared from a dry powder beverage mix formulation with the addition of the mouthfeel-improving additives of the at least one plant-derived non-beta-glucan carbohydrate fiber and the at least one beta-glucan fiber reconstituted with a drinkable liquid has an improved mouthfeel and texture as compared to a reconstituted beverage prepared from the same dry powder beverage mix formulation but without the addition of the mouthfeel-improving additives of the at least one plant-derived non-beta-glucan carbohydrate fiber and the at least one beta-glucan fiber. According to certain illustrative embodiments, the at least one plant-derived non-beta-glucan carbohydrate fiber and the at least one beta-glucan fiber are present in the dry powder beverage mix in mouthfeel-improving amounts to improve the mouth of such that the mouthfeel of the reconstituted beverage approximates or imitates the mouthfeel of a dairy yogurt drink or dairy yogurt smoothie.

According to certain embodiments, the consumable containing the plant-derived non-beta-glucan carbohydrate fiber and beta-glucan fiber is a product that can be considered to be a “clean-label” product. The “clean-label” movement is a consumer movement or trend driven by health and nutrition conscious consumers. The term “clean-label” is a term that has been adopted by the food industry, consumers, academics, and governmental regulatory agencies. A “clean-label” product is a food product that contains as few ingredients as possible, and which are generally recognized as natural, familiar, and simple ingredients. Consumers and the general public consider, perceive, or recognize the ingredients in the “clean-label” product as being healthy or wholesome, and not artificial, processed, synthetic, or to contain chemicals.

Without limitation, and only by way of illustration, the at least one plant-derived non-beta-glucan carbohydrate fiber may be derived from algae, beans, broccoli, mycoprotein, nuts, peas, potatoes, oatmeal, seeds, plant leaf protein, cereal (such as, without limitation, corn), seitan, tempeh, tofu, fruits (such as, without limitation, citrus, banana) chicory root, inulin and mixtures thereof.

According to certain illustrative embodiments, the at least one plant-derived non-beta-glucan carbohydrate fiber is derived from peas. Without limitation, the peas may be selected from black eyed peas, chickpeas, green peas and mixtures thereof.

According to certain illustrative embodiments, the at least one plant-derived non-beta-glucan carbohydrate fiber is derived from fruits. Without limitation, the fruits may be selected from one or more of citrus, banana, apple, pineapple, peach, strawberry, figs, kiwis, and the like.

Without limitation, the citrus may preferably be selected from orange, bitter orange, lemon, mandarin and mixtures thereof.

According to certain illustrative embodiments, the at least one plant-derived non-beta-glucan carbohydrate fiber may be derived from beans selected from black beans, canelli beans, kidney beans, lentil beans, lima beans, pinto beans, soy beans, white beans, mung beans and mixtures thereof.

According to certain illustrative embodiments, the at least one plant-derived non-beta-glucan carbohydrate fiber may be derived from nuts selected from almonds, brazil nuts, cashews, peanuts, pecans, hazelnuts, pine nuts, walnuts and mixtures thereof.

According to certain illustrative embodiments, the at least one plant-derived non-beta-glucan carbohydrate fibers may be derived from plant seeds selected from chia, flax, hemp, pumpkin, sesame, sunflower and mixtures thereof.

According to certain illustrative embodiments, the at least one plant-derived non-beta-glucan carbohydrate fibers may be derived from cereal selected from oatmeal, wheat, barley, spelt, corn, rice and mixtures thereof.

According to certain illustrative embodiments the at least one plant-derived non-beta-glucan carbohydrate fiber may be a water soluble fiber, a water dispersible fiber, a water insoluble fiber or mixtures thereof.

According to certain illustrative embodiments the at least one plant-derived non-beta-glucan carbohydrate fiber may be water soluble, including but limited to soluble corn dextrin, pea soluble dextrin, chicory root soluble fructan.

According to certain illustrative embodiments the at least one plant-derived non-beta-glucan carbohydrate fiber may be water insoluble including but limited to banana fibers.

According to certain illustrative embodiments the at least one plant-derived non-beta-glucan carbohydrate fiber may be water dispersible, including but limited to citrus fibers.

According to certain illustrative embodiments, the at least one beta-glucan fiber is selected from bacteria-derived beta-glucan, grain-derived beta-glucan, fungi-derived beta-glucan, yeast-derived beta-glucan, and combinations thereof. According to certain illustrative embodiments, the at least one beta-glucan fiber is selected from barley, shiitake, reishi mushrooms, seaweed, algae, wheat, oat and rye and combinations thereof.

According to certain illustrative embodiments, the at least one plant-derived non-beta-glucan carbohydrate fiber is derived from peas and the at least one beta-glucan fiber is a grain-derived beta-glucan fiber. According to certain embodiments, the at least one plant-derived non-beta-glucan carbohydrate fiber is derived from peas and the at least one beta-glucan fiber is an oat-derived beta-glucan. According to certain embodiments, the at least one plant-derived non-beta-glucan carbohydrate fiber is derived from peas and is present in a composition or dry powder beverage mix in the form of fibers and the at least one beta-glucan fiber is an oat-derived beta-glucan fibers and is present in the composition or dry powder beverage mix in the form of soluble fibers.

The amounts of the at least one plant-derived non-beta-glucan carbohydrate fiber and at least one beta-glucan fiber may be included in a consumable base at a ratio of the plant-derived non-beta-glucan carbohydrate fiber to the beta-glucan fiber is in the range from about 10:90 to about 90:10, or from about 20:80 to about 80:20, or from about 30:70 to about 70:30, or from about 40:60 to about 60:40, or from about 45:55 to about 55:45, or at any ratio from about 10:90 to about 90:10. According to certain illustrative embodiments, the ratio of the plant-derived non-beta-glucan carbohydrate fiber to the beta-glucan fiber included in the consumable is from about 40:60 to about 60:40. According to other illustrative embodiments, the ratio of the plant-derived non-beta-glucan carbohydrate fiber to the beta-glucan fiber included in the consumable base is about 50:50.

The composition or consumable may include at least one fat. The fat may be selected from animal-derived fats and plant-derived fats. Suitable animal fats include animal-derived butter fats, milk fats, lard, and the like. Without limitation, for example, the animalic fat may be derived from chicken, cow, duck, goose, pig and combinations thereof.

According to certain embodiments, fat component of the composition may comprise an oil selected from algal oils, insect oils, vegetable-derived oils and combinations. According to certain embodiments, the fat component comprises one or more vegetable-derived oils. Without limitation, and only by way of illustration, suitable vegetable oils include almond oil, avocado oil, canola oil, coconut oil, corn oil, cottonseed oil, flaxseed oil, hazelnut oil, illipe oil, linseed oil, palm oil, palm kernel oil, peanut oil, pecan oil, pumpkin seed oil, oat oil, olive oil, rapeseed oil, safflower oil, sesame oil, shea oil, soybean oil, sunflower oil, walnut oil, and mixtures thereof.

According to certain illustrative embodiments, the composition and consumable may further include at least one probiotic, at least one prebiotic, or a combination thereof. The phrase “at least one probiotic” means that the composition or consumable includes one or more than one probiotic. The phrase “at least one prebiotic” means that the composition or consumable includes one prebiotic or more than one prebiotic. According to certain illustrative embodiments, the composition or consumable may include one probiotic and more than one prebiotic. According to other illustrative embodiments, the composition or consumable may include more than one probiotic and one prebiotic. According to certain illustrative embodiments, the composition or consumable may contain one probiotic and one prebiotic. According to certain illustrative embodiments, the composition or consumable may contain more than one probiotic and more than one prebiotic. The at least one probiotic, at least one prebiotic, or combination thereof is present in the composition or consumable in an amount effective to confer or promote health benefit on a subject.

According to certain illustrative embodiments, probiotics comprise live microorganisms that confer or otherwise impart a health benefit to a subject when consumed in an effective amount. Without limitation, and only by way of illustration, suitable probiotics are selected from bacteria, yeasts, and fungi. Without being bound to any particular theory, it is believed that probiotics improve or restore a subject's naturally-occurring gastrointestinal microflora and impart health benefits apart from nutrition.

Suitable probiotics include, but are not limited to, bacteria of the genus Lactobacillus, Bifidobacieria, Streptococcus, or combinations thereof.

According to certain illustrative embodiments, the at least one probiotic may be selected from the genus Lactobacillus. Suitable non-limiting examples of Lactobacillus species found in the human intestinal tract include L. acidophilus, L. casei, L. fermentum, L. saliva roes, L brevis, L. leichmannii, L. plantarum, L. cellobiosus, L. reweri, L. rhamnosus, L. hulgaricus, and L. thermophilus.

According to certain illustrative embodiments, the at least one probiotic may be selected from the genus Bifidobacteria. Suitable non-limiting species of the genua Bifidobacteria found in the human gastrointestinal tract include B. angulatum, B. animalis, B. asteroides, B. bifdum, B. bourm, B. breve, B. catenulatum, B. choerinum. B. cogneforme, B. cuniculi, B. dentiumn, B. gallicum, B. gallinarum, B indicum, B. longwn, B. magnum, B. merycicum, B. minimum, B. pseudocatenu/atum, B. pseudolongwn, B. psychraerophilum, B. pullorum, B. ruminantium, B. saeculare, B. scardovil, B. simiae, B. subtile, B. thermacidophilum, B. thermophilum, and B. urinahs.

Prebiotics promote the growth of beneficial bacteria in the intestines. Prebiotic substances can be consumed by a relevant probiotic, or otherwise assist in keeping the relevant probiotic alive or stimulate its growth. When consumed in an effective amount, prebiotics also beneficially affect the human body's naturally-occurring gastrointestinal microflora and thereby impart health benefits apart from just nutrition. Prebiotic foods enter the colon and serve as substrate for the endogenous bacteria, thereby indirectly providing the host with energy, metabolic substrates, and essential micronutrients.

Without limitation, and only by way of illustration, prebiotics may be selected from mucopolysaccharides, oligosaccharides, polysaccharides, amino acids, vitamins, nutrient precursors, proteins and combinations thereof. According to certain illustrative embodiments, the prebiotic may be selected from dietary fibers. According to further illustrative embodiments, the dietary fibers may be selected from polysaccharides and oligosaccharides. Without limitation, and only by way of illustration, suitable oligosaccharides that are categorized as prebiotics include fructooligosaccharides, inulins, isomalto-oligosaccharides, lactilol, lactosucrose, lactulose, dextrins, soy oligosaccharides, transgalacto-oligosaccharides, and xylo-oligosaccharides. Prebiotics may be obtained from foods such as bananas, berries, asparagus, garlic, wheat, oats, flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans).

The composition may further include at least one sweetener in a sweetening-effective amount to impart a desired sweetness to the composition and the resulting consumable to which the composition is added. The at least one sweetener may comprise at least one caloric sweetener, or at least one non-caloric sweetener, or a combination of at least one caloric sweetener and at least one non-caloric sweeteners. The non-caloric sweeteners may be selected from synthetic non-caloric sweeteners and natural non-caloric sweeteners.

Without limitation, and only by way of illustration, suitable synthetic non-caloric sweeteners include acesulfame K, advantame, aspartame, cyclamate, neotame, neohesperidin dihydrochalcone, saccharin, sucrolose and combinations thereof.

Without limitation, and only by way of illustration, suitable non-caloric natural sweeteners include steviol glycosides selected from stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, dulcoside A, dulcoside B, rubusoside, and combinations thereof, mogrol glycosides selected from mogroside I, mogroside II, mogroside III, mogroside IV, mogroside V, isomogroside V, 11-oxomogroside, siamenoside I and combinations thereof, Luo Han Guo sweetener, Swingle Extract, erythritol, glycyrrhizic acid, thaumatin, brazzein, monatin and combinations thereof.

Without limitation, and only by way of illustration, suitable caloric sweeteners include sucrose, fructose, glucose, high fructose corn syrup, corn syrup, xylose, arabinose, rhamnose, erythritol, xylitol, mannitol, sorbitol, inositol, allulose and combinations thereof.

The mouthfeel-improving composition may further include nutritionally effective amounts of at least one vitamin, or at least one mineral or a combination of at least one vitamin and at least one mineral. According to certain embodiments, the composition comprises a nutritionally effective amount of at least one vitamin. According to certain embodiments, the composition comprises a nutritionally effective amount of more than one different vitamin. According to certain embodiments, the composition comprises a nutritionally effective amount of at least one mineral. According to certain embodiments, the composition a nutritionally effective amount of more than one different mineral. According to certain embodiments, the composition comprises a nutritionally effective amount of at least one vitamin and at least one mineral. According to certain embodiments, the composition comprises a nutritionally effective amount of more than one different vitamin and at least one mineral. According to certain embodiments, the composition comprises a nutritionally effective amount of at least one vitamin and more than one different mineral. According to certain embodiments, the composition comprises a nutritionally effective amount of more than one different vitamin and more than one different mineral.

The consumable composition comprises a consumable base, at least one plant-derived non-beta-glucan carbohydrate fiber, and at least one beta-glucan fiber. The consumable may comprise a liquid beverage. The terms “beverage”, “beverage composition” and “beverage product” are used interchangeably herein to mean ready-to-drink beverages, beverage concentrates, beverage syrups, or powdered beverages.

According to illustrative embodiments, the beverage comprises a ready-to-drink beverage. The term “ready-to-drink” beverage as used herein means a beverage in liquid form ready to be consumed without further addition of liquid. The ready-to-drink beverage may comprise any other suitable ingredients known in the art for producing a beverage, such aa, for example, sweeteners (natural or artificial sweeteners); aromas and flavors; milk and/or milk derivatives; acidifiers; stabilizers; natural colors; or any combination thereof. Ready-to-drink beverages are packaged beverages that are sold in a prepared form and are ready for consumption. According to other embodiments, the ready-to-drink beverage may comprise a dry concentrate (for examples powders or granulates) which are indented to be dissolved in water before consumption.

Without limitation, suitable ready-to-drink beverages include carbonated and non-carbonated beverages. Carbonated beverages include, but are not limited to, frozen carbonated beverages, enhanced sparkling beverages, cola, fruit-flavored sparkling beverages (e.g., lemon-lime, orange, grape, strawberry and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g., black tea, green tea, red tea, oolong tea), coffee, cocoa drink, dairy beverage, beverages comprising milk components (e.g., milk beverages, coffee comprising milk components, cafe au lait, milk tea, fruit milk beverages), beverages comprising cereal extracts, yogurt drinks and smoothies.

According to certain embodiments, the ready-to-drink beverage is a dairy beverage. Dairy beverages, dairy-derived beverages and dairy-alternative products include, but are not limited to, milk, fluid milk, cultured milk product, cultured and noncultured dairy-based drinks, cultured milk product cultured with lactobacillus, yoghurt-based beverage, lassi, milk shake, acidified milk, acidified milk beverage, soy milk, rice milk, rice milk drink, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured milk drinks, dairy only flavoured milk drinks, soy milk, sour milk drinks, fermented dairy drinks, coffee whiteners, powder milk, flavoured powder milk drinks, drinking yoghurt, regular probiotic drinking yoghurt. The term “milk” includes, but is not limited to, whole milk, skim milk, condensed milk, evaporated milk, reduced fat milk, low fat milk, nonfat milk, and milk solids (which may be fat or nonfat). According to certain embodiments, the dairy beverage is a yogurt beverage, such as, for example, a yogurt smoothie.

Additionally disclosed is a method for preparing a consumable. The method for preparing the consumable comprises adding to a consumable base at least one plant-derived non-beta-glucan carbohydrate fiber and at least one beta-glucan fiber. The at least one non-beta-glucan carbohydrate fiber and at least one beta-glucan fiber are added to the consumable base in amounts to improve the mouthfeel of the consumable.

Further disclosed is a method of improving the mouthfeel of a consumable comprising. The method comprises adding sufficient amounts of at least one plant-derived non-beta-glucan carbohydrate fiber and beta-glucan fiber to a consumable base to improve the mouthfeel of the consumable.

Mouthfeel (or “mouth feel”) refers to the physical sensations experienced or felt in the mouth that are created by food and beverages, or compositions added to food or beverages. Mouthfeel may refer to textures that come into contact with the tongue, roof of the mouth, teeth, gums, or throat. Mouthfeel is considered to be distinct from taste/flavor, but is considered to have an equal or even greater impact on a person's enjoyment or preference for certain foods over others. Typical mouthfeel descriptors used to describe perceived sensations include acidity (metallic, citrusy, bright), density (close, airy), dryness (arid, scorched), graininess (particulate, powdery, dusty, grainy, chalky), gumminess (chewy, tough), hardness (crunchy, soft), heaviness (full, weighty), irritation (prickly, stinging), mouth coating (oily, buttery), roughness (abrasive, textured), slipperiness (slimy, stringy), smoothness (satiny, velvety), uniformity (even, uneven) and viscosity (full-bodied, light-bodied).

Particularly preferred embodiments are:
1. A composition comprising at least one plant-derived non-beta-glucan carbohydrate fiber and at least one beta-glucan fiber.
2. A composition comprising at least one plant-derived non-beta-glucan carbohydrate fiber and at least one beta-glucan fiber as mouthfeel-improving additives.
3. The composition of embodiment 1, wherein the at least one plant-derived non-beta-glucan fiber is selected from the group consisting of water soluble fiber, water dispersible fiber, water insoluble fiber, and mixtures thereof.
4. The composition of embodiment 3, wherein the water soluble fiber is selected from the group consisting of corn dextrin, pea soluble dextrin, chicory root soluble fructan, and mixtures thereof.
5. The composition of embodiment 1, wherein the at least one plant-derived non-beta-glucan fiber comprises water dispersible fiber.
6. The composition of embodiment 1, wherein the at least one plant-derived non-beta-glucan fiber comprises water insoluble fiber.
7. The composition of embodiment 1, wherein said plant-derived non-beta-glucan carbohydrate fiber is derived from algae, beans, broccoli, mycoprotein, nuts, peas, potatoes, oatmeal, seeds, plant leaf protein, cereal, seitan, tempeh, tofu, fruits, chicory root, inulin and mixtures thereof.
8. The composition of embodiment 7, wherein said plant-derived non-beta-glucan carbohydrate fiber is derived from peas.
9. The composition of embodiment 8, wherein said peas are selected from the group consisting of black eyed peas, chickpeas, green peas and mixtures thereof.
10. The composition of embodiment 7, wherein said plant-derived non-beta-glucan carbohydrate fiber is derived from beans selected from the group consisting of black beans, canelli beans, kidney beans, lentil beans, lima beans, pinto beans, soy beans, white beans, mung beans and mixtures thereof.
11. The composition of embodiment 7, wherein said plant-derived non-beta-glucan carbohydrate fiber is derived from nuts selected from the group consisting of almonds, brazil nuts, cashews, peanuts, pecans, hazelnuts, pine nuts, walnuts and mixtures thereof.
12. The composition of embodiment 7, wherein said plant-derived non-beta-glucan carbohydrate fiber is derived from plant seeds selected from the group consisting of chia, flax, hemp, pumpkin, sesame, sunflower and mixtures thereof.
13. The composition of embodiment 7, wherein said plant-derived non-beta-glucan carbohydrate fiber is derived from cereal selected from the group consisting of oatmeal, corn, wheat, barley, spelt, corn, rice and mixtures thereof.
14. The composition of embodiment 7, wherein said plant-derived non-beta-glucan carbohydrate fiber is selected from fruits selected from the group consisting of apple, banana, citrus, figs, kiwi, peach, pineapple, strawberry, and mixtures thereof.
15. The composition of embodiment 14, wherein the citrus is selected from orange, bitter orange, lemon, mandarin, and mixtures thereof.
16. The composition of embodiment 1, wherein said beta-glucan fiber is selected from bacteria-derived beta-glucan, grain-derived beta-glucan, fungi-derived beta-glucan, yeast-derived beta-glucan, and combinations thereof.
17. The composition of embodiment 16, wherein said beta-glucan fiber is a grain-derived beta-glucan.
18. The composition of embodiment 17, wherein said grain-derived beta-glucan is derived from oat.
19. The composition of embodiment 1, wherein the at least one beta-glucan fiber is derived from barley, shiitake mushroom, reishi mushroom, seaweed, algae, oat, wheat, rye and mixtures thereof.
20. The composition of embodiment 1, wherein the ratio of the plant-derived non-beta-glucan carbohydrate fiber to the beta-glucan fiber is in the range from about 10:90 to about 90:10, or from about 20:80 to about 80:20, or from about 30:70 to about 70:30, or from about 40:60 to about 60:40, or from about 45:55 to about 55:45.
21. The composition of embodiment 20, wherein the ratio of the plant-derived non-beta-glucan carbohydrate fiber to the beta-glucan fiber is from about 40:60 to about 60:40.
22. The composition of embodiment 21, wherein the ratio of the plant-derived non-beta-glucan carbohydrate fiber to the beta-glucan fiber is about 50:50.
23. The composition of embodiment 1, wherein the composition is in powdered form.
24. A consumable comprising a consumable base, plant-derived non-beta-glucan carbohydrate fiber, and beta-glucan fiber.
25. The consumable of embodiment 24, wherein the consumable comprises a beverage.
26. The consumable of embodiment 25, wherein the beverage comprises a ready-to-drink beverage.
27. The consumable of embodiment 26, wherein said ready-to-drink beverage is a dairy beverage.
28. The consumable of embodiment 27, wherein the dairy beverage is a yogurt beverage.
29. The consumable of embodiment 28, wherein the yogurt beverage is a yogurt smoothie.
30. A method for preparing a consumable comprising adding to a consumable base at least one plant-derived non-beta-glucan carbohydrate fiber and at least one beta-glucan fiber.
31. A method of improving the mouthfeel of a consumable comprising adding mouthfeel-improving amounts of at least one plant-derived non-beta-glucan carbohydrate fiber and at least one beta-glucan fiber to a consumable base.
32. Use of a combination of at least one plant-derived non-beta-glucan carbohydrate fiber and at least one beta-glucan fiber to improve the mouthfeel of a consumable.

### EXAMPLES

### Example 1-Orange Peach Mango Smoothie Powder Mix

An orange peach mango flavored dry powder smoothie mix was prepared with the following ingredients:

| Ingredient | gram/serving | % w/w powder | % w/w RTD |
|---|---|---|---|
| Fermented Protein | 12.500 | 46.296 | 4.764 |
| Pea Fiber | 1.420 | 5.259 | 0.538 |
| Beta-Glucan Fiber | 5.320 | 19.704 | 2.015 |
| Fat | 1.000 | 3.704 | 0.379 |
| Sweetener | 4.509 | 16.700 | 1.708 |
| Flavor | 1.783 | 6.604 | 0.675 |
| Masker | 0.258 | 0.956 | 0.098 |
| Probiotic | 0.067 | 0.248 | 0.025 |
| Vitamin C | 0.118 | 0.437 | 0.045 |
| Color | 0.025 | 0.093 | 0.009 |
| Sub-Total | 27.000 | 100.00 | 10.227 |
| Water | 237.00 | — | 89.773 |
| Total | 264.000 | 100.00 | 100.00 |

The ratio of the pea-derived non-beta-glucan carbohydrate fiber to the beta-glucan fiber is about 50:50 and can be calculated according to the following table:

| | | | Beta | | | Non-beta |
|---|---|---|---|---|---|---|
| | Ingredient | Beta | glucan | Total | Fiber | Glucan |
| | (g/ | Glucan | (g/ | Fiber | (g/ | (g/ |
| Ingredient | serving) | % | serving) | % | serving) | serving) |
| Beta | 5.32 | 29.00 | 1.54 | 36.00 | 1.92 | 0.36 |
| Glucan | | | | | | |
| fiber | | | | | | |
| Pea | 1.42 | 0.00 | 0.00 | 83.50 | 1.19 | 1.19 |
| Protein | | | | | | |
| Fiber | | | | | | |
| Total | 6.74 | — | 1.54 | — | 3.10 | 1.55 |

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

The compositional weight percentages disclosed herein are based on the total weight of the composition or consumable, as the situation dictates. It will be understood to one of ordinary skill in the art that the total weight percent of the compositions and consumable cannot exceed 100%. For example, a person of ordinary skill in the art would easily recognize and understand that a composition comprising xₐ to yₐ weight percent of a plant-derived non-beta-glucan carbohydrate fiber, x_{b} to y_{b} weight percent beta-glucan fiber, and x_{c} to y_{c} weight percent further additives will not exceed 100%. A person of ordinary skill in the art would understand that the amount of the components may be adjusted to include the desired amount of component without exceeding 100% by weight of the composition or consumable.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

As used in this specification, the terms “comprises,” “comprising,” “contains,” “containing,” “includes,” “including,” “has,” or “having,” are all open-ended expressions and are intended to cover apparatus, compositions, methods, processes, products, or systems that comprise a recited list of components, elements, and features, and any and all additional components, elements and features that are not expressly recited. The terms “includes,” “including,” “has,” or “having” are not intended to have a more narrow construction, interpretation, or meaning than the terms “comprises” or “comprising.”

As used in the present specification, the term “or” refers to an inclusive “or” and not to an exclusive “or”. For example, the phrase “A or B” is satisfied by any one of the following: A is present and B is not present, A is not present and B is present, and both A and B are present.

As used in the present specification, “a” or “an” is employed to describe components, elements, features and method/process steps of various illustrative embodiments disclosed herein. The use of “a” or “an” should be interpreted to include one or more than one.

As used in the present specification, any of the terms “illustratively,” “preferably,” “commonly,” and “typically” are not intended to, and do not, limit the scope of the claimed embodiments, or to imply that certain features are critical, essential, important, or required to the structure or function of the claimed composition, beverage product or methods. Rather, these terms are merely intended to identify particular aspects of an embodiment or to emphasize alternative or additional features that may or may not be utilized in a particular embodiment.

While the compositions, process for making for the compositions, process for using the compositions, and the consumables have been described above in connection with certain illustrative embodiments, it is to be understood that other embodiments may be used or modifications and additions may be made to the described embodiments for performing the same function of the present embodiments without deviating therefrom. Further, all embodiments disclosed are not necessarily in the alternative, as various embodiments of the invention may be combined to provide the desired characteristics. Variations can be made by one having ordinary skill in the art without departing from the spirit and scope of the disclosure. Therefore, the present disclosure should not be limited to any single embodiment, but rather construed in breadth and scope in accordance with the recitation of the attached claims.

1. A composition comprising at least one plant-derived non-beta-glucan carbohydrate fiber and at least one beta-glucan fiber as mouthfeel-improving additives.

2. The composition of claim 1, wherein the water soluble fiber is selected from the group consisting of corn dextrin, pea soluble dextrin, chicory root soluble fructan, and mixtures thereof.

3. The composition of claim 1, wherein said plant-derived non-beta-glucan carbohydrate fiber is derived from algae, beans, broccoli, mycoprotein, nuts, peas, potatoes, oatmeal, seeds, plant leaf protein, cereal, seitan, tempeh, tofu, fruits, chicory root, inulin and mixtures thereof.

4. The composition of claim 3, wherein said plant-derived non-beta-glucan carbohydrate fiber is selected from fruits selected from the group consisting of apple, banana, citrus, figs, kiwi, peach, pineapple, strawberry, and mixtures thereof.

5. The composition of claim 4, wherein the citrus is selected from orange, bitter orange, lemon, mandarin, and mixtures thereof.

6. The composition of claim 1, wherein said beta-glucan fiber is selected from bacteria-derived beta-glucan, grain-derived beta-glucan, fungi-derived beta-glucan, yeast-derived beta-glucan, and combinations thereof.

7. The composition of claim 1, wherein the at least one beta-glucan fiber is derived from barley, shiitake mushroom, reishi mushroom, seaweed, algae, oat, wheat, rye and mixtures thereof.

8. The composition of claim 1, wherein the ratio of the plant-derived non-beta-glucan carbohydrate fiber to the beta-glucan fiber is in the range from about 10:90 to about 90:10.

9. The composition of claim 1, wherein the composition is in powdered form.

10. A consumable comprising a consumable base, plant-derived non-beta-glucan carbohydrate fiber and beta-glucan fiber according to the claim 1 composition, wherein the consumable comprises a beverage.

11. The consumable of claim 10, wherein the beverage comprises a ready-to-drink beverage.

12. The consumable of claim 11, wherein said ready-to-drink beverage is a dairy beverage.

13. A method for preparing a consumable comprising adding to a consumable base at least one plant-derived non-beta-glucan carbohydrate fiber and at least one beta-glucan fiber according to the claim 1 composition.

14. A method of improving the mouthfeel of a consumable comprising adding mouthfeel-improving amounts of at least one plant-derived non-beta-glucan carbohydrate fiber and at least one beta-glucan fiber to a consumable base.

15. A method of improving the mouthfeel of a consumable, the method comprising adding a combination of at least one plant-derived non-beta-glucan carbohydrate fiber and at least one beta-glucan fiber to said consumable.

16. The composition of claim 1, wherein the at least one plant-derived non-beta-glucan fiber is selected from the group consisting of water soluble fiber, water dispersible fiber, water insoluble fiber, and mixtures thereof.

17. The composition of claim 3, wherein said plant-derived non-beta-glucan carbohydrate fiber is derived from peas.

18. The composition of claim 6, wherein said beta-glucan fiber is a grain-derived beta-glucan.

19. The composition of claim 18, wherein said beta-glucan fiber is derived from oat.

20. The composition of claim 8, wherein the ratio of the plant-derived non-beta-glucan carbohydrate fiber to the beta-glucan fiber is in the range from about 20:80 to about 80:20.
